(19) United States
(12) Patent Application Publication
(10) Pub. No.: US 2018/0319393 A1
(43) Pub. Date: Nov. 8, 2018

(54) System And Method For Collision Mitigation And Avoidance In Autonomous Vehicle

(71) Applicant: GM GLOBAL TECHNOLOGY OPERATIONS LLC, Detroit, MI (US)

(72) Inventors: Youssef P. Najjar, Flushing, MI (US); Sachin K. Pindolia, Canton, MI (US)

(21) Appl. No.: 15/588,939

(22) Filed: May 8, 2017

(51) Int. Cl. B60W 30/09; G05D 1/00; B60R 22/46; B60R 21/16; B60R 21/0134

(52) U.S. Cl. CPC B60W 30/09; G05D 1/0088; B60W 2550/10; B60R 21/16; B60R 21/0134; B60R 22/46

(57) ABSTRACT

A method of controlling a vehicle according to the present disclosure includes detecting an object in a target region proximate the vehicle. The method additionally includes anticipating a collision with the object based on a relative position, relative velocity, and relative acceleration of the object. The method further includes activating a collision preparation mode in response to anticipating the collision.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

A method of controlling a vehicle having at least one controller with an automated driving system configured to control vehicle steering according to the present disclosure includes detecting an object in a target region proximate the vehicle. The method additionally includes anticipating a collision with the object based on a relative position, relative velocity, and relative acceleration of the object. The method further includes controlling the vehicle, via the at least one controller, according to a collision avoidance and mitigation mode in response to anticipating the collision.

In an exemplary embodiment, the vehicle has a fore portion and an aft portion, and wherein the target region is proximate the aft portion.

In an exemplary embodiment, the collision avoidance and mitigation mode includes an autonomous avoidance maneuver.

In an exemplary embodiment, the collision avoidance and mitigation mode includes activating an occupant protection system in advance of the anticipated collision.

In an exemplary embodiment, the collision avoidance and mitigation mode includes providing a collision notification to a vehicle occupant or a third party.

A vehicle according to the present disclosure includes an actuator configured to control vehicle steering, acceleration, braking, or shifting. The vehicle additionally includes at least one controller configured to control the actuator according to an automated driving system. The vehicle further includes a sensor arranged to detect the presence of an object in a target region proximate the vehicle. The controller is programmed to anticipate a collision with a detected object based on a relative position, relative velocity, and relative acceleration of the object, and to control the vehicle according to a collision avoidance and mitigation mode in response to anticipating the collision.

In an exemplary embodiment, the vehicle additionally includes a fore portion and an aft portion, and the target region is proximate the aft portion.

In an exemplary embodiment, the controller is configured to, in the collision avoidance and mitigation mode, control the actuator to perform an autonomous avoidance maneuver.

In an exemplary embodiment, the vehicle additionally includes an occupant protection system. In such an embodiment, the controller is configured to, in the collision avoidance and mitigation mode, activate the occupant protection system in advance of the anticipated collision. The occupant protection system may include a restraint belt, and activating the occupant protection system may include modifying a tension of the restraint belt. The occupant protection system may include an airbag, and activating the occupant protection system may include deploying the air bag.

In an exemplary embodiment, the controller is configured to, in the collision avoidance and mitigation mode, provide a collision notification to a vehicle occupant or a third party. The third party may include a remote access center in wireless communication with the controller.

An autonomous vehicle according to the present disclosure includes a fore portion, an aft portion, at least one actuator configured to control vehicle steering, acceleration, braking, or shifting, at least one sensor, and at least one controller. The sensor is configured to provide a signal indicating a presence of an object proximate the aft portion. The controller is configured to control the at least one actuator according to an autonomous driving system. The controller has a first mode and a second mode. The controller is configured to, in response to the signal, discontinue control according to the first mode and begin control according to the second mode.

In an exemplary embodiment, the controller is programmed to, in response to the signal, determine a relative path of the object based on a relative position, relative velocity, and relative acceleration of the object, to anticipate a collision in response to the relative path, and to discontinue control according to the first mode and begin control according to the second mode in further response to the anticipated collision.

In an exemplary embodiment, the vehicle additionally includes an occupant protection system, and the controller is configured to, in the second mode, activate the occupant protection system in advance of the anticipated collision. The occupant protection system may include a restraint belt, and activating the occupant protection system may include modifying a tension of the restraint belt. The occupant protection system may include an airbag, and activating the occupant protection system may include deploying the air bag.

In an exemplary embodiment, the controller is configured to, in the second mode, control the at least one actuator to perform an autonomous avoidance maneuver to remove the vehicle from the relative path of the object.

In an exemplary embodiment, the controller is configured to, in the second mode, provide a collision notification to a vehicle occupant or a third party.

Embodiments according to the present disclosure provide a number of advantages. For example, the present disclosure provides a system and method for anticipating a collision due to an object aftward of the vehicle, and taking appropriate action to mitigate or avoid the anticipated or imminent collision.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure; and

FIG. 3 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

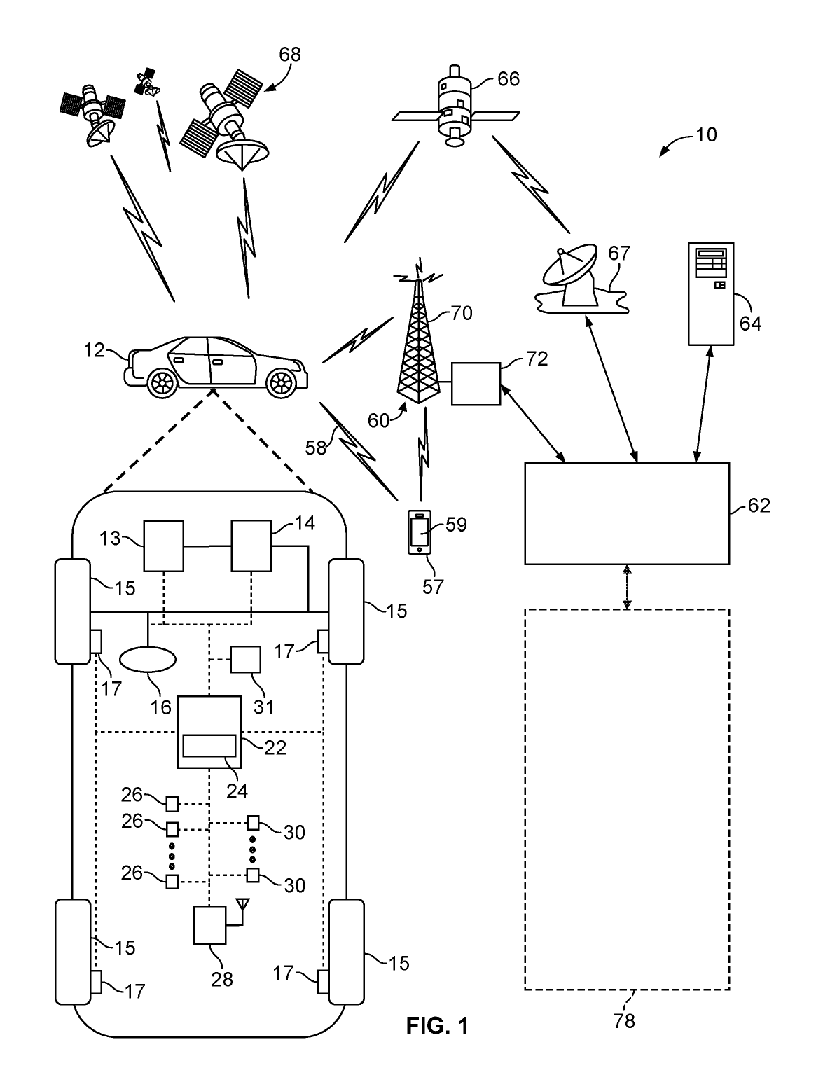

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

The vehicle 12 additionally includes at least one occupant protection system 31, such as an air bag or seat belt. The occupant protection system 31 is configured to restrain or otherwise protect an occupant in the case of a collision.

The propulsion system 13, transmission 14, steering system 16, wheel brakes 17, and occupant protection system 31 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Three, Level Four, or Level Five automation system. A Level Three system indicates “conditional automation”, referring to the driving mode-specific performance by an automated driving system of all aspects of the dynamic driving task with the expectation that the human driver will respond appropriately to a request to intervene. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice, text, and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62, such as Near Field Communication, Bluetooth®, or other data connections. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12, the station 67, and/or other vehicles. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle and/or infrastructure in addition to the vehicle 12. The vehicle 12 and any supplemental vehicles may be collectively referred to as a fleet.

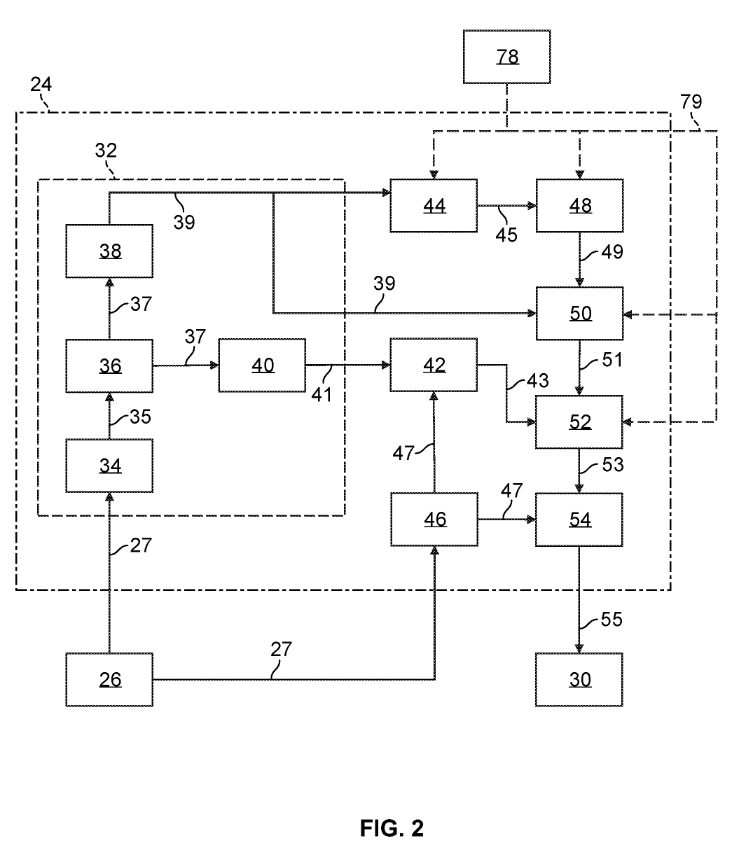

As shown in FIG. 2, the ADS 24 includes multiple distinct control systems, including at least a perception system 32 for determining the presence, relative location, classification, and relative path of detected features or objects in the vicinity of the vehicle 12. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light and signage classification, object segmentation, ground segmentation, map classification, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in a driving environment, such as, for example, manhole covers, bridges, overhead trees or light poles, vehicles in cross-traffic, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, traffic information and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an onboard database, an online database, or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

In a conventional vehicle under the control of a human driver, the driver will generally maintain an awareness of objects behind the vehicle. As an example, a driver may observe a rearward vehicle approaching at high velocity, and subsequently perform a maneuver to avoid the approaching vehicle. However, vehicles under the control of an automated driving system may be programmed with a focus on avoiding objects to the fore of the vehicle.

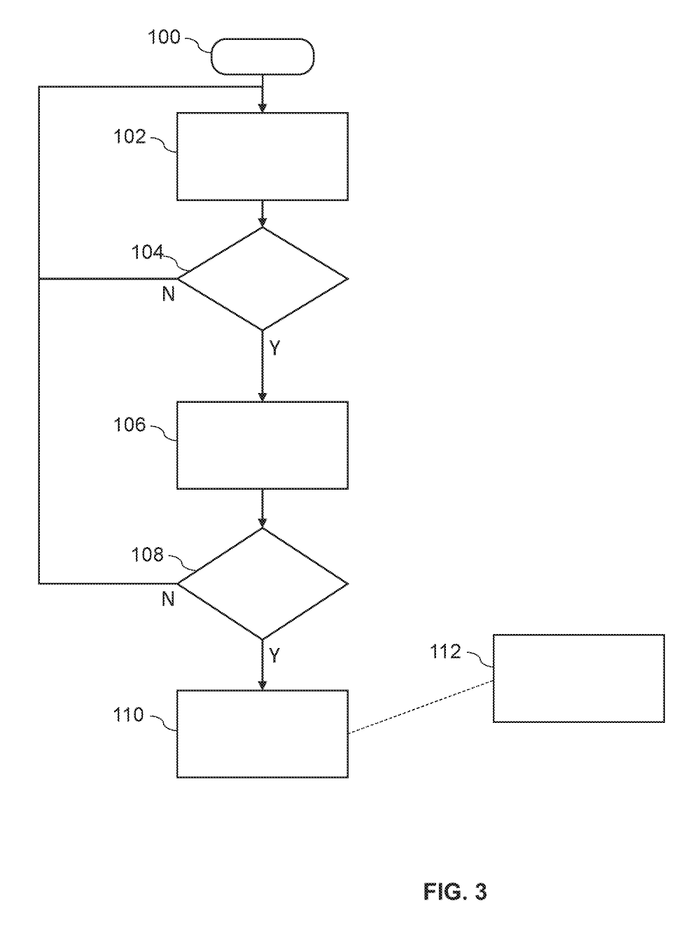

Referring now to FIG. 3, a method of controlling a vehicle according to the present disclosure is illustrated in flowchart form. The method begins at block 100, with the vehicle operating in an autonomous mode under the control of an automated driving system, e.g. according to a default autonomous control algorithm.

Signals are received from at least one exterior-facing sensor, as illustrated at block 102. In an exemplary embodiment, the sensor or sensors are among the sensors 26 illustrated in FIG. 1. In an exemplary embodiment, the sensor or sensors include a RADAR or LiDAR array arranged to detect a region aft of the vehicle, as illustrated at block 102.

A determination is made of whether an object is detected in a target region proximate the vehicle, as illustrated at operation 104. In an exemplary embodiment, the target region is aft of the vehicle, e.g. within a 90 degree or 180 degree arc oriented to the rear of the vehicle, as illustrated at operation 104.

If the determination of operation 104 is negative, control returns to block 102. As may be seen, the algorithm does not proceed unless and until an object is detected in the target region. The

If the determination of operation 104 is positive, a relative position, relative velocity, and relative acceleration of the detected object are determined, as illustrated at block 106. This determination may be made, for example, based on the signals received at block 102.

A determination is made of whether a collision with the detected object is anticipated, as illustrated at operation 108. This determination may be made, for example, based on the relative position, relative velocity, and relative acceleration determined in block 106. A collision may be anticipated if the collision will occur in the absence of any change in behavior of the vehicle, e.g. if the relative path of the detected object would intersect the vehicle. An anticipated collision may be referred to as imminent if the collision will occur regardless of any change in behavior of the vehicle.

If the determination of operation 108 is negative, control returns to block 102. As may be seen, the algorithm does not proceed unless and until a collision is anticipated.

If the determination of operation 108 is positive, then a collision avoidance and mitigation mode is activated, as illustrated at block 110. The collision avoidance and mitigation mode may include performing an autonomous avoidance maneuver to remove the vehicle from the path of the detected object, e.g. by controlling vehicle steering and/or acceleration to move the vehicle out of the path of the detected object, as illustrated at block 112. The collision avoidance and mitigation mode may also include engaging an occupant protection system, e.g. in response to an anticipated imminent collision, as also illustrated at block 112. In an exemplary embodiment, this may include deploying an air bag in advance of an imminent collision, adjusting tension in a seat belt, other mitigation system, or combination thereof. The collision avoidance and mitigation mode may also include providing a collision notification to a vehicle occupant or a third party, e.g. by generating an audio alarm or by transmitting a diagnostic signal via V2V, V2I, or other similar means. In an exemplary embodiment, a collision notification is provided to the remote access center 78, an emergency responder, or both.

While the above has been described with respect to autonomous vehicles, aspects of the present disclosure may likewise be implemented in conventional vehicles, e.g. to engage occupant restraint or other passive systems in advance of an anticipated collision.

As may be seen, the present disclosure provides a system and method for anticipating a collision due to an object aftward of the vehicle, and taking appropriate action to mitigate or avoid the anticipated or imminent collision.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle having at least one controller with an automated driving system configured to control vehicle steering, comprising:
detecting an object in a target region proximate the vehicle;
anticipating a collision with the object based on a relative position, relative velocity, and relative acceleration of the object; and
controlling the vehicle, via the at least one controller, according to a collision avoidance and mitigation mode in response to anticipating the collision.

2. The method of claim 1, wherein the vehicle has a fore portion and an aft portion, and wherein the target region is proximate the aft portion.

3. The method of claim 1, wherein the collision avoidance and mitigation mode includes an autonomous avoidance maneuver.

4. The method of claim 1, wherein the collision avoidance and mitigation mode includes activating an occupant protection system in advance of the anticipated collision.

5. The method of claim 1, wherein the collision avoidance and mitigation mode includes providing a collision notification to a vehicle occupant or a third party.

6. A vehicle comprising:
an actuator configured to control vehicle steering, acceleration, braking, or shifting;
at least one controller configured to control the actuator according to an automated driving system; and
a sensor arranged to detect the presence of an object in a target region proximate the vehicle;
wherein the at least one controller is programmed to anticipate a collision with a detected object based on a relative position, relative velocity, and relative acceleration of the object, and to control the vehicle according to a collision avoidance and mitigation mode in response to anticipating the collision.

7. The vehicle of claim 6, further comprising a fore portion and an aft portion, wherein the target region is proximate the aft portion.

8. The vehicle of claim 6, wherein the controller is configured to, in the collision avoidance and mitigation mode, perform an autonomous avoidance maneuver.

9. The vehicle of claim 6, further comprising an occupant protection system, wherein the controller is configured to, in the collision avoidance and mitigation mode, activate the occupant protection system in advance of the anticipated collision.

10. The vehicle of claim 9, wherein the occupant protection system includes a restraint belt, and wherein activating the occupant protection system includes modifying a tension of the restraint belt.

11. The vehicle of claim 9, wherein the occupant protection system includes an airbag, and wherein activating the occupant protection system includes deploying the air bag.

12. The vehicle of claim 6, wherein the controller is configured to, in the collision avoidance and mitigation mode, provide a collision notification to a vehicle occupant or a third party.

13. The vehicle of claim 12, wherein the third party includes a remote access center in wireless communication with the controller.

14. An autonomous vehicle comprising:
a fore portion;
an aft portion;
at least one actuator configured to control vehicle steering, acceleration, braking, or shifting;
at least one sensor configured to provide a signal indicating a presence of an object proximate the aft portion; and
at least one controller configured to control the at least one actuator according to an autonomous driving system, the at least one controller having a first mode and a second mode, the at least one controller being configured to, in response to the signal, discontinue control according to the first mode and begin control according to the second mode.

15. The autonomous vehicle of claim 14, wherein the at least one controller is programmed to, in response to the signal, determine a relative path of the object based on a relative position, relative velocity, and relative acceleration of the object, to anticipate a collision in response to the relative path, and to discontinue control according to the first mode and begin control according to the second mode in further response to the anticipated collision.

16. The autonomous vehicle of claim 15, further comprising an occupant protection system, wherein the at least one controller is configured to, in the second mode, activate the occupant protection system in advance of the anticipated collision.

17. The vehicle of claim 16, wherein the occupant protection system includes a restraint belt, and wherein activating the occupant protection system includes modifying a tension of the restraint belt.

18. The vehicle of claim 16, wherein the occupant protection system includes an airbag, and wherein activating the occupant protection system includes deploying the air bag.

19. The vehicle of claim 16, wherein the at least one controller is configured to, in the second mode, control the at least one actuator to perform an autonomous avoidance maneuver to remove the vehicle from the relative path of the object.

20. The vehicle of claim 16, wherein the at least one controller is configured to, in the second mode, provide a collision notification to a vehicle occupant or a third party.
